(19) United States
(12) Patent Application Publication
(10) Pub. No.: US 2021/0004924 A1
(43) Pub. Date: Jan. 7, 2021

(54) SELECTIVE EVENT-DRIVEN ELECTRONIC COMMUNICATION

(71) Applicant: It Matters For Life, LLC, Tomkins Cove, NY (US)

(72) Inventors: Robert Sims, Round Rock, TX (US); Eric Jaslow, Tomkins Cove, NY (US)

(21) Appl. No.: 16/502,988

(22) Filed: Jul. 3, 2019

(51) Int. Cl. G06Q 50/18; H04L 12/58; G06Q 40/02; G06F 16/21

(52) U.S. Cl. CPC G06Q 50/186; G06F 16/21; G06Q 40/02; H04L 51/34

(57) ABSTRACT

In a least one embodiment, a processor of a data processing system maintains, in data storage, a record identifying a plurality of assets managed by a manager. The processor also maintains, in data storage, a record identifying a plurality of contacts for communication regarding the plurality of assets and associations between selected ones of the plurality of assets and different ones of the plurality of contacts. The processor detects occurrence of an event in which the managing party fails to communicate electronically within a time period, based on detecting occurrence of the event, transmits an electronic communication regarding an asset among the plurality of assets to an associated contact among the plurality of contacts.

### BACKGROUND OF THE INVENTION

The present invention relates to electronic communication, and more specifically, to selective event-driven electronic communication.

It is typical for a person to manage a variety of different tangible and intangible assets, such as bank accounts, retirement accounts, brokerage accounts, safe deposit boxes, insurance policies, improved or unimproved real property, oil and gas royalty interests, intellectual property, cemetery plots, leases, licenses, contracts, pensions, annuities, etc., whether on his or her own behalf or on behalf of an entity, such as a commercial business. Many of these assets may be associated with different accounts with third parties, such as financial institutions, insurance agents, lessees, lessors, licensees, asset managers, financial advisors, brokers, etc. As the number of assets and accounts under management grows, the burden of tracking the existence and location of the assets and of administering the accounts increases dramatically. In the personal context, it is common for few, if any, individuals other than the person managing the assets to be aware of the full scope of the assets and accounts. Even in cases in which individuals other than the person managing the assets have awareness of the existence of some or all of the assets, it is common for individuals other than the asset manager to be unaware of identifiers for the accounts (e.g., account names and/or numbers) and/or the appropriate contact(s) at the third parties for those accounts.

### BRIEF SUMMARY

The present disclosure appreciates that in the event of the death, incapacity, or unavailability of the individual managing of the assets, knowledge of the assets and/or accounts may be lost. As a consequence, the entity owning the assets or the heirs, trustees, beneficiaries, and/or successors-in-interest to the assets may be unable to locate, use, maintain, and/or benefit from the assets and/or accounts.

In one or more embodiments, the foregoing challenges can be addressed by an improved method, data processing system, and program product for electronic communication. In one embodiment, a processor of a data processing system maintains, in data storage, a record identifying a plurality of assets managed by a manager. The processor also maintains, in data storage, a record identifying a plurality of contacts for communication regarding the plurality of assets and associations between selected ones of the plurality of assets and different ones of the plurality of contacts. The processor detects occurrence of an event in which the managing party fails to communicate electronically within a time period, based on detecting occurrence of the event, transmits an electronic communication regarding an asset among the plurality of assets to an associated contact among the plurality of contacts.

It should be appreciated that although this new modality of electronic communication has clear commercial application, this new modality of electronic communication does not constitute a method of doing business per se.

### BRIEF DESCRIPTION OF THE SEVERAL VIEWS OF THE DRAWINGS

FIG. 1 is a high-level block diagram of an electronic communication environment in accordance with one embodiment;

FIG. 2 is a block diagram of an electronic communication device in accordance with one embodiment;

FIG. 3 is a block diagram of an application service provider platform in accordance with one embodiment;

FIG. 4 is a high-level logical flowchart of an exemplary process for configuring electronic communication in accordance with one embodiment;

FIG. 5 illustrates a graphical user interface of an electronic communication application in accordance with one embodiment; and

FIG. 6 is a high-level logical flowchart of an exemplary process for electronic communication in accordance with one embodiment.

### DETAILED DESCRIPTION

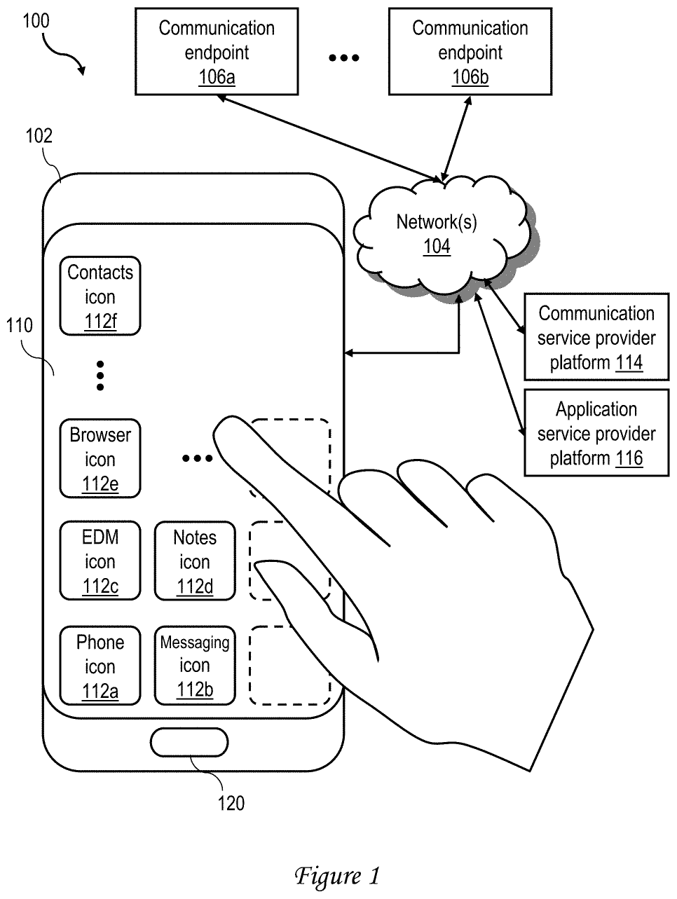

With reference now to the figures, and in particular with reference to FIG. 1, there is illustrated an electronic communication environment 100 in which the inventions disclosed herein may advantageously be utilized. Electronic communication environment 100 includes an electronic communication device 102, which, as described in greater detail below, may be utilized to communicate electronically with one or more additional electronic devices, such as communication endpoints 106a, 106b via one or more communication networks 104. In various realizations of electronic communication environment 100, communication network(s) 104 may include, for example, a wireless wide-area network (WAN) including a plurality of distributed terrestrial, atmospheric and/or satellite-based antennae supporting long range two-way radio frequency communication. Communication network(s) 104 may alternatively or additionally include one or more circuit-switched and/or packet-switched communication networks, including, for example, the Internet.

Communication between electronic communication device 102 and other electronic devices may be handled directly by the devices themselves (i.e., via peer-to-peer communication) and/or may be facilitated by a third party platform, such as a communication service provider platform 114 or application service provider platform 116. Communication service provider platform 114 is a data processing system associated with and/or operated by a network infrastructure or network service company that provides one or more electronic communication services (e.g., Internet, telephony, text messaging, etc.) to one or more of electronic communication device 102 and communication endpoints 106. Application service provider platform 116 is a data processing system associated with and/or operated by a source or provider of one or more of electronic communication applications that can executed to provide electronic communication between electronic communication device 102, communication endpoints 106, and/or application service provider platform 116, as discussed further below. These network-connected third party platforms 114, 116 may serve as intermediaries that relay electronic communication between communication endpoints 102, 106, and may provide temporary and/or long term storage of the content of electronic communication between electronic communication device 102, communication endpoints 106, and/or application service provider platform 116.

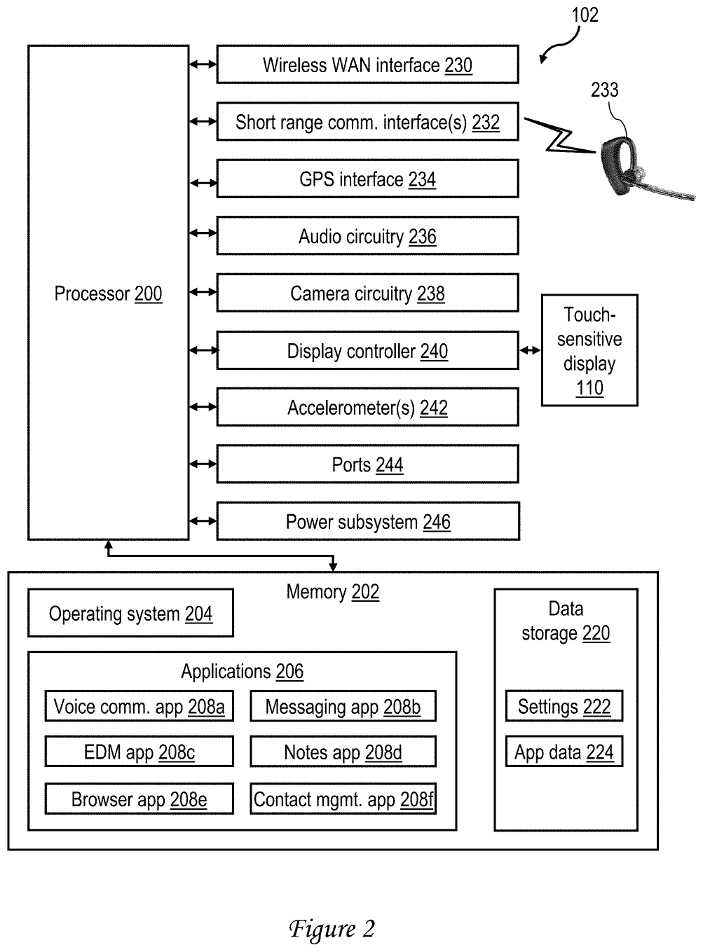

In the illustrated embodiment, electronic communication device 102 may comprise, for example, a data processing system, such as a smartphone, smart watch, computer system (e.g., desktop, laptop or tablet), display device (e.g., television set), gaming console, etc. In each of these embodiments, electronic communication device 102 includes and/or is coupled to a display device, which may be (but is not required to be) a touch-sensitive display device 110. Electronic communication device 102 may optionally include one or more manually manipulable input buttons 120. Although not required, in the depicted example, electronic communication device 102 presents within display device 110 a graphical user interface including one or more icons 112a-112f, each of which may be selected by a user to invoke execution of a corresponding application by electronic communication device 102. (Exemplary applications are illustrated in FIG. 2.) In the illustrated example, phone icon 112a corresponds to a voice communication application 208a (which may include video call capability, for example, as supported by Apple® FaceTime™), messaging icon 112b corresponds to a messaging (e.g., texting) application 208b, event-driven messaging (EDM) icon 112c corresponds to an EDM application 208c, notes icon 112d corresponds to a notes (e.g., text editing) application 208d, browser icon 112e corresponds to a browser application 208e, and contacts icon 112f corresponds to a contact management application 208f. As is known in the art, electronic communication device 102 may execute multiple of these applications concurrently. Further, in some implementations, the functionality of some of these applications (e.g., voice communication application 208a, and/or messaging application 210, and/or EDM application 208c, and/or notes application 208d) can be combined into a single application, implemented within a common application framework, and/or invoked from another of the applications. For example, in some embodiments, the functionality of an application, such as EDM application 208c, can be delivered to electronic communication device 102 through browser application 208e.

In some embodiments of electronic communication environment 100, one or more of communication endpoints 106a, 106b may be implemented similarly to electronic communication device 102. One or more of communication endpoints 106a, 106b may alternatively or additionally be implemented as an intelligent device (e.g., smart speaker) having an embedded processor. Networks environments including such devices are sometimes referred to as the Internet-of-Things (IOTs).

Referring now to FIG. 2, there is depicted a high-level block diagram of an exemplary embodiment of electronic communication device 102 in which electronic communication device 102 is implemented, for example, as a smartphone, desktop computer, laptop computer, tablet computer, or smart speaker. As illustrated, electronic communication device 102 includes a processor 200, which may include one or more processor cores for executing program code (e.g., software and/or firmware). As shown, processor 200 is coupled, either directly or indirectly, to a variety of different components within electronic communication device 102. For example, processor 200 is coupled to a memory 202 (e.g., dynamic random access memory (DRAM), static random access memory (SRAM), flash memory, and/or magnetic or optical disk drive, etc.), which provides storage for data and program code (e.g., software and/or firmware) executed by processor 200. The program code stored within memory 202 includes an operating system 204, as well as applications (“apps”) 206. As indicated, in this embodiment, applications 206 include voice communication application 208a, messaging (texting) application 208b, EDM application 208c, notes (text editing) application 208d, browser application 208e, and contact management application 208f. In some embodiments, voice communication application 208a, messaging (texting) application 208b, notes application 208d, browser application 208e, and contact management application 208f can be (but need not be) conventional. EDM application 208c, which supports new electronic communication modalities, is described in detail below.

The data storage 220 of memory 202 may include input data and output data of the processing performed by processor 200. Data accessed and/or processed by applications 206 is referred to herein as application data 224. Data storage 220 may also store settings 222 that control and/or customize the operation of electronic communication device 102 and/or the program code it executes.

Electronic communication device 102 may include a number of additional components providing, supporting and/or expanding its processing, storage, and/or communication capabilities. For example, electronic communication device 102 includes a wireless WAN interface (e.g., a transceiver and antenna) 230 supporting two-way wireless radio frequency communication with communication network(s) 104. In order to support communication with other electronics within close range, electronic communication device 102 may be further equipped with one or more short range communication interface(s) 232, which may implement protocols for 802.11x, Bluetooth, 900 MHz communication, or the like. As one exemplary use, short range communication interfaces may be utilized to interface input/output device(s), such as a Bluetooth headset 233, to electronic communication device 102. Electronic communication device 102 may further include a global positioning satellite (GPS) interface (e.g., GPS receiver and GPS antenna) that receives GPS signals from GPS satellites and processes the GPS signals to provide location information to processor 200.

Electronic communication device 102 may also include audio circuitry 236 (e.g., at least an audio interface optionally further coupled to microphone(s) and speaker(s)), camera circuitry 238, a display controller 240 that controls the presentation of video and/or image data via touch-sensitive display 110, and accelerometers 242. One or more ports 244 may also optionally be utilized to expand the processing, communication and/or data storage capabilities of electronic communication device 102. Finally, electronic communication device 102 includes a power subsystem 246 that powers processor 200 and the other components of electronic communication device 102. Power subsystem 246 may include, for example, a battery and/or power port through which the battery may be charged from an AC power source or wireless inductive charging device.

Although FIG. 2 illustrates a number of components separately for ease of understanding, it will be appreciated by those skilled in the art that, in at least some embodiments, multiple of the illustrated components may be integrated within a common integrated circuit die or package. It should also be understood that the illustrated components are not required in all embodiments and are also not exhaustive of the components in all embodiments. Consequently, other embodiments may include a greater or fewer number of components.

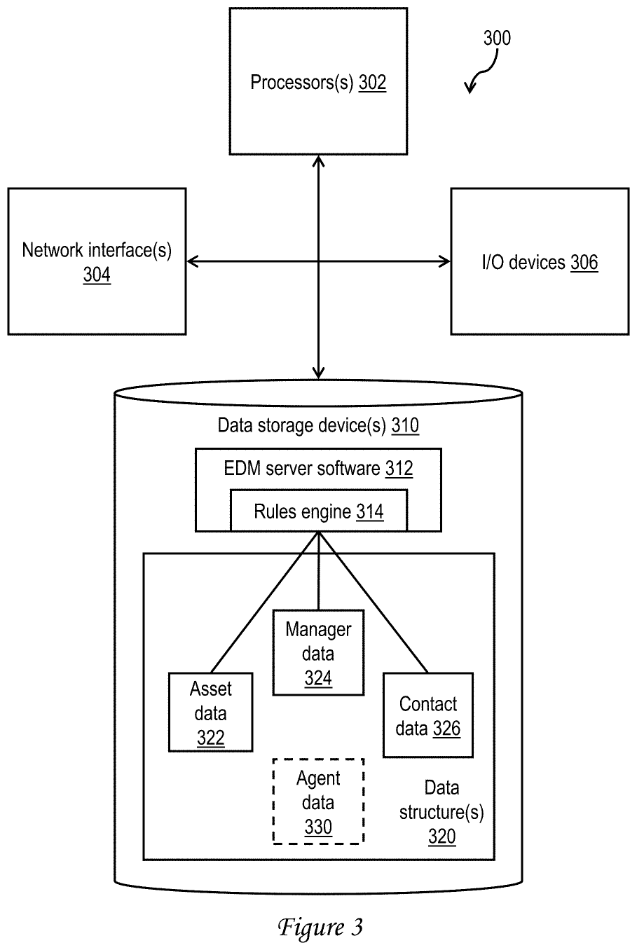

With reference now to FIG. 3, there is illustrated a data processing system 300 that can be utilized to implement application service provide platform 116 in accordance with one or more embodiments. In various embodiments, data processing system 300 may be, for example, a server computer system or a cloud computing node. It should be understood that the high-level block diagram provided in FIG. 3 is not exhaustive and that various embodiments may include different suitable combinations of hardware, software, and firmware.

In the illustrated exemplary embodiment, data processing system 300 includes one or more processors 302 that process data and program code, for example, to ingest, manage, access, manipulate, output and/or store data and/or software. Data processing system 300 additionally includes one or more network interfaces 304 coupled to processor(s) 302 that permit data processing system 300 to communicate with one or more other data processing systems (e.g., electronic communication device 102 and/or communication endpoints 106) via cabling and/or network(s) 104. Data processing system 300 also includes input/output (I/O) devices 306, such as ports, displays, and attached devices, etc., which receive inputs and provide outputs of the processing performed by data processing system 300 and/or other resource(s) in its data processing environment. Finally, data processing system 300 includes one or more data storage device(s) 310 coupled to processor(s) 302. Data storage device(s) 310 may include, for example, one or more volatile or non-volatile storage devices, including cache memories, system memories, solid state drives, optical or magnetic disk drives, etc. Data storage device(s) 310 may store, for example, input data to be processed by processor(s) 302, software to direct the processing of processor(s) 302, and/or data results of processing by processor(s) 302. Generally, the software stored within data storage device(s) 310 may include routines, programs, objects, components, logic, data structures, and so on that perform particular tasks or implement particular abstract data types. If data processing system 300 is implemented as a portion of a distributed computing environment, modules of software may be executed in data processing system 300 and/or in other remote data processing systems, and data processing system 300 may additionally execute modules of software residing in the other remote data processing systems.

In the depicted embodiment, the software stored in data storage device(s) 310 and executed by processor(s) 302 may include possibly conventional operating system and webserver software, as well as event-driven messaging (EDM) server software 312. As described in greater detail below, EDM server software 312 initiates, monitors, and controls electronic communication between various parties associated with a collection of assets utilizing a rules engine 314. EDM server software 312 records data relevant to managing collections of assets in one or more data structures 314, which may include directories, folders, files, databases, lists, etc. Data structure(s) 314 contain at least asset data 322 identifying assets in one or more asset collections (and possibly including assets within the asset collection), manager data 324 that includes data regarding the owners and/or managers of collections of assets, and contact data 326 that includes data regarding contacts for various assets in the collections of assets. Data structure(s) 320 may optionally include agent data 330 that includes data regarding authorized agents for the owners/managers, who are permitted to build out manager data 324, asset data 322 and/or contact data 326 on behalf of the owners/managers.

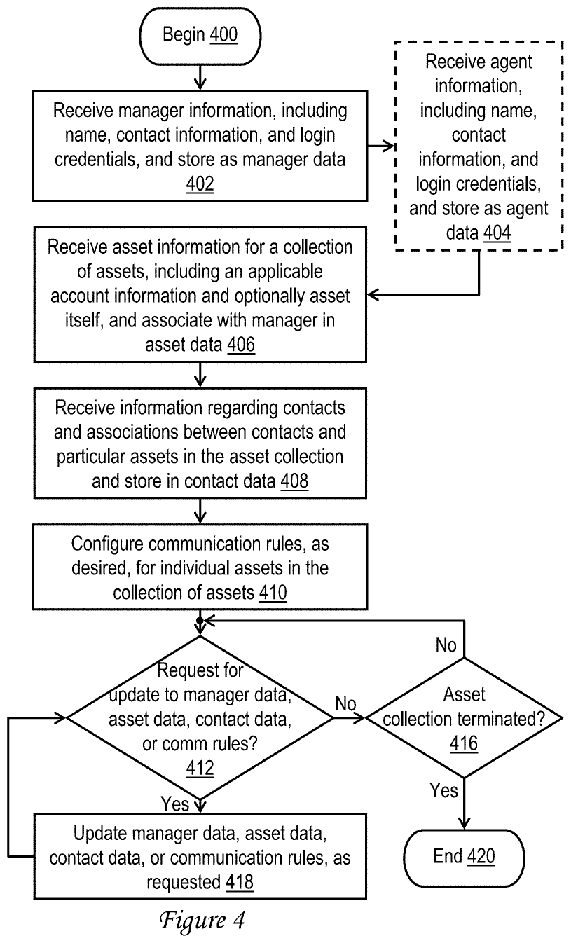

Referring now to FIG. 4, there is depicted a high-level logical flowchart of an exemplary process for configuring electronic communication in accordance with one embodiment. To promote greater understanding, the illustrated process will be described with reference to the embodiments illustrated in FIGS. 1-3.

The process of FIG. 4 begins at block 400 and then proceeds to block 402, which illustrates EDM server software 312 receiving manager information, including a manager name, manager contact information, and manager login credentials, for example, from an EDM application 208c executing on an electronic communication device 102. The entry of the manager information can be performed by the manager (e.g., an asset owner) and/or, if permitted by EDM application 208c and EDM server software 312, an authorized agent of the manager. The manager information received at block 402 can be stored within data structure(s) 320 as part of manager data 324. As indicated at optional block 404, if at least a portion of the manager information received at block 402 is entered by an authorized agent of the manager, EDM server software 312 also preferably requires and receives agent information, such as an agent name, agent contact information, and agent login credentials (block 404). As above, the agent information can be received by EDM server software 312 from an EDM application 208c executing on an electronic communication device 102. EDM server software 312 may store the agent information received at optional block 404 within data structure(s) 320 as agent data 330.

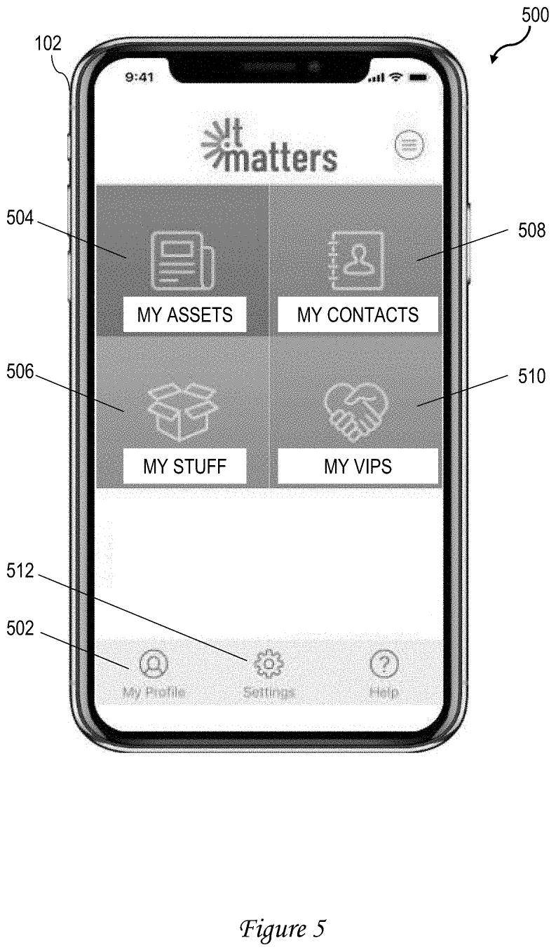

FIG. 5 illustrates an exemplary graphical user interface 500, which can be presented by an EDM application 208c within display 110 of electronic communication device 102 to facilitate electronic communication between EDM application 208c and EDM server software 312 in accordance with one embodiment. In this example, graphical user interface 500 includes a My Profile control 502, which when selected, invokes the presentation of an interface through which the manager and/or the authorized agent of the manager can enter and/or update the manager information and/or the agent information.

Returning to FIG. 4, the process passes from block 402 or optional block 404 to block 406, which depicts EDM server software 312 receiving asset information identifying tangible and/or intangible assets in a collection of assets under management by the manager. The assets can be, for example, bank accounts, retirement accounts, brokerage accounts, trusts, safe deposit boxes, insurance policies, improved or unimproved real property, oil and gas royalty interests, intellectual property, cemetery plots, leases, licenses, contracts, pensions, annuities, physical equipment, etc. The asset information can include, but is not required to include, one or more account numbers (e.g., of bank or brokerage accounts, loan accounts, credit accounts, tax accounts, insurance policies, vendor accounts, etc.) for various accounts under management by the manager. In the embodiment illustrated in FIG. 5, entry of the asset information can be invoked by the manager or an authorized agent of the manager from an instance of an EDM application 208c executing on an electronic communication device 102 by the selection of My Assets control 504.

In some cases, the asset information may include documents, images, videos, or other electronic files evidencing or constituting the asset itself or ownership of the asset (e.g., a work of authorship (e.g., computer program, book, artwork, image, journal article, etc.), title or deed document, insurance policy, certificate of insurance, ownership certificate, contract, unit of cryptocurrency, blockchain entry, etc.). In the embodiment of FIG. 5, these electronic files can be uploaded from EDM application 208c to EDM server software 312, for example, through an interface presented by EDM application 208c in response to selection of My Stuff control 506.

In response to receipt of the asset information, EDM server software 312 stores the asset information in data structure(s) 320 in association with the manager as asset data 322. In some implementations, the association between the manager and the asset information is indicated, for example, by common storage in the same data structure 320 or by a pointer or other data structure link.

For some assets, such as accounts held with third parties, it is common for the asset to be supervised by or under the administrative purview of an assigned third party representative, such as an insurance agent, financial advisor, banker, property manager, etc. EDM server software 312 optionally but preferably permits the manager or the manager's authorized agent to associate such third party representatives and their respective contact information with particular assets in the asset collection. EDM server software 312 can store the identities of the third party representatives within data structure(s) 320, for example, as part of asset data 322 or in a separate data set. In graphical user interface 500 of FIG. 5, the manager of an asset collection can view a listing or directory of all the third party representatives that are associated with assets in the asset collection via an interface accessed through selection of My VIPs control 510.

Referring now to block 408 of FIG. 4, EDM server software 312 additionally receives information regarding contacts for the collection of assets under management by the manager. The contacts can be, for example, familial relatives of the manager, co-workers of the manager, beneficiaries or heirs of the manager, trustees of one or more assets, and/or successors-in-interest or successors-in-control with respect to assets in the asset collection. The information regarding the contacts can include, for example, the names of the contacts and contact information for the contacts (e.g., email address, physical address phone number, email address, social media handle, etc.). In a preferred embodiment, EDM server software 312 enables, if desired, one or more different contacts to be identified for each asset in the asset collection formed at block 406. Of course, in some cases, it will be desirable for the manager to designate the same contact for two or more of the assets in the asset collection. In the embodiment illustrated in FIG. 5, entry of the information regarding the contacts can be invoked by the manager or the manager's authorized agent from EDM application 208c by the selection of My Contacts control 508. In response to receipt of the information regarding contacts at block 408, EDM server software 312 stores the information regarding contacts in data structure(s) 320 as contact data 326.

In at least one embodiment, EDM server software 312 additionally allows the manager and/or an authorized agent to assign different access levels to different ones of the contacts at block 408, where each access level reflects a different degree of relationship with the manager and/or assets in the asset collection. For example, in one embodiment, EDM server software 312 supports an immediate access level, which provides a contact so-designated with on-demand read-only visibility to the asset data 322 of the asset(s) associated with that contact. Thus, a contact having the immediate access level can, at any time, login into EDM server software 312, for example, via an instance of EDM application 208c executing on the contact's communication endpoint 106, and view all information regarding one or more assets with which that contact is associated by the manager of the asset(s). For example, in at least some cases, the immediate access level is suitable for assignment to a spouse of the manager, a co-trustee of one or more of the assets, a co-worker, a conservator or attorney-in-fact of the manager, etc.

EDM server software 312 preferably additionally supports the designation of a contact as having a primary access level, which enables EDM server software 312 to provide the contact with a notification (e.g., an application notification, browser notification, email message, text message, voice call, etc.) in response to EDM server software 312 detecting that the manager has not electronically communicated with EDM server software 312 within a time period measured by the expiration of a corresponding timer. As discussed below, EDM server software 312 does not permit the contact assigned the primary access level to have any access to the asset data 322 regarding the asset(s) with which the contact is associated prior to or immediately following expiration of the timer. Rather, the notification is intended to cause the primary contact to encourage the manager to electronically communicate with EDM server software 312, thus validating the availability and capacity of the manager to continue managing the collection of assets. If EDM server software 312 does not receive an electronic communication from the manager prior to subsequent expiration of another timer, EDM server software 312 thereafter permits the contact assigned the primary access level to have any access to the asset data 322 regarding the asset(s) with which the contact has been associated by the manager.

As will be appreciated, additional access levels, such as a secondary access level, tertiary access level, etc. can additionally be defined. As with the primary access level described above, a contact assigned one of these access levels may, for example, receive a notification if the manager has not electronically communicated with EDM server software 312 within a time period measured by the expiration of a corresponding timer. If EDM server software 312 does not receive an electronic communication from the manager prior to subsequent expiration of another timer, EDM server software 312 will thereafter permit the contact assigned the lower access level (e.g., secondary, tertiary, etc.) to have access to the asset data 322 regarding the asset(s) with which the contact has been associated by the manager.

Block 410 illustrates EDM server software 312 configuring communication rules, as desired by the manager, for individual assets and/or contacts for those individual assets. The communication rules, which can be stored as part of asset data 322, preferably establish one or more timer durations for each of the assets in the asset collection and specify which of the contacts is to receive an electronic communication in response to occurrence of a timer expiration event. For example, the manager may establish a first timer duration of 6 months, representing a time period in which EDM server software 312 is to receive an electronic communication from the owner (e.g., the owner logging in to EDM server software 312 via an instance of EDM application 208c or responding to an application notification, browser notification, email message, text message, or voice message prompt). If no electronic communication is received by EDM server software 312 within the first timer duration, EDM server software 312 may initiate electronic communication to the owner via EDM application 208c and/or one or more other electronic communication modalities (e.g., an application notification, browser notification, email message, text message, or voice message prompt). The manager may further establish durations of one or more additional timers, representing one or more additional time period(s) at the end of which EDM server software 312 will initiate communication with one or more of the contacts (e.g., based on their assign access levels) if no electronic communication from the manager is received between expiration of the first timer and expiration of the additional timer(s). In one example, the manager can establish default communication rules via Settings control 512 of graphical user interface 500 in FIG. 5. In at least some embodiments, communication rules for individual assets can also be established utilizing an interface accessible via My Assets control 504. Once established at block 410, these communication rules will control the electronic communication behavior of rules engine 314.

Block 412 illustrates EDM server software 312 monitoring for receipt, for example, from an instance of EDM application 308c or browser application 208e executing on the electronic communication device 102 of the manager, of a request to update (e.g., add, remove, or modify) the manager data 324, asset data 322, contact data 326, or the communication rules. In response to receipt of such a request, EDM server software 312 updates manager data 324, asset data 322, contact data 326, or the communication rules within data structure(s) 320, as requested (block 418). As noted at block 416, EDM server software 312 also monitors for termination of the asset collection, for example, by deletion of all assets from the asset collection by the manager or the manager's authorized agent. In response to termination of the asset collection, the process of FIG. 4 ends at block 420.

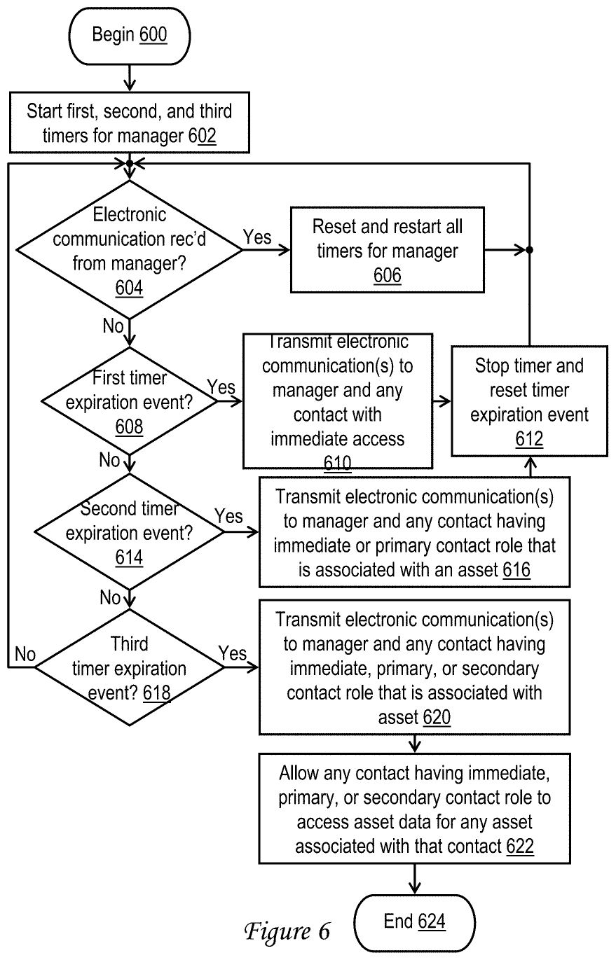

Referring now to FIG. 6, there is depicted a high-level logical flowchart of an exemplary process for electronic communication in accordance with one embodiment. The illustrated process can be performed, for example, by EDM server software 312 for each individual manager among a plurality of managers with whom electronic communication is monitored.

The process of FIG. 6 begins at block 600 and then proceeds to block 602, which depicts EDM server software 312 starting a plurality of timers by reference to which electronic communication with the manager is monitored. In the depicted example, EDM server software 312 starts first, second, and third timers, each having successively later expirations. The process then proceeds to block 604, which illustrates EDM server software 312 monitoring for receipt of an electronic communication from the manager. As noted above, the electronic communication from the manager can comprise, for example, the manager logging into EDM server software 312 via an instance of EDM application 308c executing on the manager's electronic communication device 102. In response to a determination at block 604 that an electronic communication from the manager has been received by EDM server software 312, EDM server software 312 resets and restarts all of the timers for the manager (block 606). The process then returns to block 604, which has been described.

In response to a determination at block 604 that an electronic communication has not been received from the manager, EDM server software 312 determines at block 608 whether or not the first timer has expired (i.e., a first timer expiration event has occurred). If so, EDM server software 312 transmits one or more electronic communications to the manager (and optionally, one or more contacts granted immediate access to at least one asset in the manager's asset collection) via one or more communication modalities (e.g., application notification, browser notification, email message, text message, voice call, etc.) (block 610). These electronic communications to the manager can thereafter be repeated one or more times at interval(s) as determined by the communication rules applied by rules engine 314. Following block 610, EDM server software 312 stops the first timer and resets the first timer expiration event (so that the first timer expiration event will no longer be detected), as depicted at block 612. Thereafter, the process returns to block 604.

In response to a determination at block 608 that the first timer expiration event is not detected, EDM server software 312 determines at block 614 whether or not the second timer has expired (i.e., a second timer expiration event has occurred). If not, the process passes to block 618, which is described below. If, however, EDM server software 312 detects at block 614 that the second timer expiration event is detected, EDM server software 312 transmits one or more electronic communications to the manager and additionally to one or more contacts assigned an immediate or primary contact role by the manager via one or more communication modalities (e.g., application notification, browser notification, email message, text message, voice message, etc.) (block 616). These electronic communications to the manager and to the contact(s) assigned immediate or primary level access can thereafter be repeated one or more times at interval(s) as determined by the communication rules applied by rules engine 314. Following block 616, EDM server software 312 stops the second timer and resets the second timer expiration event so that the second timer expiration event will not thereafter be detected (block 612). Thereafter, the process returns to block 604, which has been described.

Referring now to block 618, EDM server software 312 determines whether or not the third timer has expired (i.e., a third timer expiration event has occurred). If not, the process returns to block 604, which has been described. If, however, EDM server software 312 detects at block 618 that the third timer expiration event has occurred, EDM server software 312 transmits one or more electronic communications to the manager and additionally to any contacts assigned an immediate, primary, or secondary access level via one or more communication modalities (e.g., application notification, browser notification, email message, text message, voice message, etc.) (block 620). These electronic communications to the manager and to the contact(s) can thereafter be repeated one or more times at interval(s) as determined by the communication rules applied by rules engine 314.

In contrast to the earlier electronic communications, which simply provide notification of the first or second timer expiration event and prompt the relevant contacts to encourage the manager to communicate electronically with EDM server software 312, the electronic communication transmitted at block 620 preferably provides each of the contacts access to the asset(s) in the asset collection that are associated by asset data 322 with that contact. Thus, for example, the contact is invited to establish login credential to EDM server software 312 via an instance of EDM application 308c executing on a communication endpoint 106 and, once logged in, to access, from asset data 322, the account number, the contact information for the third party representative, and/or other relevant information regarding the associated assets of the manager. Thus, as indicated at block 622, any contact having immediate, primary, or secondary access level for an asset in the asset collection of the manager is permitted to access asset data 322 of any asset associated with that contact. Such access may include read access, downloading any electronic file attached to the asset by the manager, receiving account names and account numbers, receiving contact information for third party representatives associated with assets, etc. Thereafter, the process of FIG. 6 ends at block 624.

As has been described, in a least one embodiment, a processor of a data processing system maintains, in data storage, a record identifying a plurality of assets managed by a manager. The processor also maintains, in data storage, a record identifying a plurality of contacts for communication regarding the plurality of assets and associations between selected ones of the plurality of assets and different ones of the plurality of contacts. The processor detects occurrence of an event in which the managing party fails to communicate electronically within a time period, based on detecting occurrence of the event, transmits an electronic communication regarding an asset among the plurality of assets to an associated contact among the plurality of contacts.

While various inventions have been particularly shown as described with reference to one or more preferred embodiments, it will be understood by those skilled in the art that various changes in form and detail may be made therein without departing from the spirit and scope of the invention. For example, although various embodiments have been described in which various functions are performed through the execution of one or more applications on an electronic communication device, it should be appreciated that in other embodiments the inventive functions may be performed on an application service provider platform 116 accessed by the electronic communication device, for example, through execution of a browser application 216 or other remote access software. Similarly, it should be appreciated that the described functions need not all be performed on a single physical platform, but can instead be performed on multiple communicatively coupled physical platforms (e.g., which may be communicatively coupled via short range communication interfaces 232 or wireless WAN interfaces 230).

In the figures referenced herein, each block of a flowchart or block diagram may represent a module, segment, or portion of executable instructions or objects for implementing the specified logical function(s). Although the flowcharts contained herein necessarily depict processing steps being performed in a particular order, it will be appreciated by those skilled in the art that in various embodiments at least some of the processing steps can be performed concurrently, in a partially temporally overlapping manner, or in a different order than depicted. It should also be appreciated that each block of the block diagrams and/or flowcharts, as well as combinations of blocks in the block diagrams and/or flowcharts, can be implemented by special purpose hardware that perform the specified functions.

The inventions disclosed herein may be realized as a system, a method, and/or a computer program product. A computer program product may include a storage device having computer-readable program code stored thereon for causing a processor to carry out aspects of the inventions. The storage device may be, for example, an electronic storage device, a magnetic storage device, an optical storage device, an electromagnetic storage device, a semiconductor storage device, or any suitable combination of the foregoing. Specific examples of the storage device include a portable computer diskette, hard disk, random access memory (RAM), static random access memory (SRAM), read-only memory (ROM), an erasable programmable memory (EPROM or Flash memory), compact disc (CD), digital versatile disk (DVD), and a memory stick. A “storage device,” as used herein, is specifically defined to include only statutory subject matter and to exclude non-statutory subject matter, such as signal media per se, transitory propagating signals per se, and energy per se.

What is claimed is:

1. A method of electronic communication, the method comprising:
a processor of a data processing system maintaining, in data storage, a record identifying a plurality of assets managed by a managing party;
the processor maintaining, in data storage, a record identifying a plurality of contacts for communication regarding the plurality of assets;
the processor creating associations between selected ones of the plurality of assets and different ones of the plurality of contacts;
the processor detecting occurrence of an event in which the managing party fails to communicate electronically within a time period; and
the processor, based on detecting occurrence of the event, transmitting an electronic communication regarding an asset among the plurality of assets to an associated contact among the plurality of contacts.

2. The method of claim 1, and further comprising:
the processor transmitting an electronic communication to the managing party; and
the processor determining the time period with reference to transmission of the electronic communication.

3. The method of claim 1, wherein the detecting includes detecting the managing party failing to login to an online account within the time period.

4. The method of claim 1, wherein:
the time period is a first time period, the event is a first event, and the electronic communication is a first electronic communication;
the method further comprises:
the processor detecting occurrence of a second event in which the managing party fails to communicate electronically within a second time period; and
the processor, based on detecting occurrence of the second event, providing, via a second electronic communication, increased access to the asset by the contact.

5. The method of claim 1, and further comprising:
the processor receiving identification of the plurality of assets and the plurality of contacts from a mobile application.

6. The method of claim 1, and further comprising:
the processor, based on input of the asset manager, building a custom rules set for the plurality of assets; and
the processor applying the custom rules set to regulate visibility of account information for the plurality of assets to the plurality of contacts.

7. The method of claim 1, and further comprising:
the processor electronically receiving and storing, in data storage, one of the plurality of assets.

8. A data processing system, comprising:
data storage; and
a processor coupled to the data storage, wherein the processor is configured to perform:
maintaining, in the data storage, a record identifying a plurality of assets managed by a managing party;
maintaining, in data storage, a record identifying a plurality of contacts for communication regarding the plurality of assets;
creating associations between selected ones of the plurality of assets and different ones of the plurality of contacts;
detecting occurrence of an event in which the managing party fails to communicate electronically within a time period; and
based on detecting occurrence of the event, transmitting an electronic communication regarding an asset among the plurality of assets to an associated contact among the plurality of contacts.

9. The data processing system of claim 8, wherein the processor is further configured to perform:
transmitting an electronic communication to the managing party; and
determining the time period with reference to transmission of the electronic communication.

10. The data processing system of claim 8, wherein the detecting includes detecting the managing party failing to login to an online account within the time period.

11. The data processing system of claim 8, wherein:
the time period is a first time period, the event is a first event, and the electronic communication is a first electronic communication;
the processor is further configured to perform:
detecting occurrence of a second event in which the managing party fails to communicate electronically within a second time period; and
based on detecting occurrence of the second event, providing, via a second electronic communication, increased access to the asset by the contact.

12. The data processing system of claim 8, wherein the processor is further configured to perform:
receiving identification of the plurality of assets and the plurality of contacts from a mobile application.

13. The data processing system of claim 8, wherein the processor is further configured to perform:
based on input of the asset manager, building a custom rules set for the plurality of assets; and
applying the custom rules set to regulate visibility of account information for the plurality of assets to the plurality of contacts.

14. The data processing system of claim 8, wherein the processor is further configured to perform:
electronically receiving and storing, in the data storage, one of the plurality of assets.

15. A program product, comprising:
a storage device; and
program code stored within the storage device that, when executed by a processor, causes the processor to perform:
maintaining, in the data storage, a record identifying a plurality of assets managed by a managing party;
maintaining, in data storage, a record identifying a plurality of contacts for communication regarding the plurality of assets;
creating associations between selected ones of the plurality of assets and different ones of the plurality of contacts;
detecting occurrence of an event in which the managing party fails to communicate electronically within a time period; and
based on detecting occurrence of the event, transmitting an electronic communication regarding an asset among the plurality of assets to an associated contact among the plurality of contacts.

16. The program product of claim 15, wherein the program code causes the processor to perform:
transmitting an electronic communication to the managing party; and
determining the time period with reference to transmission of the electronic communication.

17. The program product of claim 15, wherein the detecting includes detecting the managing party failing to login to an online account within the time period.

18. The program product of claim 15, wherein:
the time period is a first time period, the event is a first event, and the electronic communication is a first electronic communication;
the program code causes the processor to perform:
detecting occurrence of a second event in which the managing party fails to communicate electronically within a second time period; and
based on detecting occurrence of the second event, providing, via a second electronic communication, increased access to the asset by the contact.

19. The program product of claim 15, wherein the program code causes the processor to perform:
receiving identification of the plurality of assets and the plurality of contacts from a mobile application.

20. The program product of claim 15, wherein the program code causes the processor to perform:
based on input of the asset manager, building a custom rules set for the plurality of assets; and
applying the custom rules set to regulate visibility of account information for the plurality of assets to the plurality of contacts.

21. The program product of claim 15, wherein the program code causes the processor to perform:
electronically receiving and storing, in the data storage, one of the plurality of assets.
